SEQUENCE LISTING (4 sequences)

SEQ ID NO: 1 - DNA, 601 bp, Homo sapien
ttctttctgcctttgtatcattcagacacactgtgttcactcatcagtggttctcaaaaggagaggagcacaccagactcttaagtaagggtgtgtgtgcttgtgtgtggggaggtggggggatggtctgaaaactctcccccggagataaatatattcctaccaggggtgctgtctcctcacctccctctttgggaatcactggcttctactagagtggaagacagatgtatcattagatcgatcagttgatccatatttatctgctcccagtctggaggtctggttctgggagctgagrggacaccaggggaggataagacactttctgaccaagacattttttgatctctcatcttataaggttcgtggtcactttggggagatcatatctgtcacccaacataaccatattatgataagagccaaaagtagatagggtcagttcacgtgcttcgagttcacagggactatgggtctaaggagccggggtggaggaaacagacatcgtcaatggtggcttcacgggagggagatgggatctcaactgggcccttggaggagaagctgccacgacctcccccaacaccttgacattaaa

SEQ ID NO: 2 - DNA, 801 bp, Homo sapien
ttcggtggggcaaaggagaagagtgcaacaggccagatgtggtcctccttgacagggaccttgggctaactcacagggactttgctcagaggaacactggaagggtaatgtgaccccaaaacagagtctgggtgagtggacaaaacccaggggccggggtctgtgagcagcccagccagaggacgatgcggctgtgagagcctgcaagaaggtgagcttctgagagctgccgagggccgagctccaggaagaaaagaccccgctggaagagtaaggctgacccggtcagtcaggttccaccctccctgcacaccgtcccctctcttctgaccccacgccccctcaccctggaggactcaggaagcacagctggtggacagggctgcaggtataagattcgytcaagactaggactctgctggagcccttagctggtaaggggcagggccaggtggccagggcaggtctgattctggagtttgcgtcagctcttggggaattgagcaaccccgggtcaactgacttgctgcttgtcctgttcccaggccaaggccctgcaagtacccgaggtgggggccctcaatgccttctcttatttataaatagcgagagaggaaggaaagaagggaggcctggaggagaaggaaaaagctgaaagcacggcatctgtggtgccctctgctcttccggccgccattagcacagccttctttggggatcttcatggctttattattattttttcatttatagaaagagaccgggtcttgctatgttgtccagactggtcttgaactcctg

SEQ ID NO: 3 - DNA, 786 bp, Homo sapien
ccacagagggcccttgggcgtgggggaagtggtcatctctcaggtttgaggtagaggctgtggggctgggccctgggtcctcccaaagcaactcacctttgatctgttttataaagtagggcctgcgaaggctttttgttagagacagaccaacagtgtgtcatatcatagtatttcattcattctccatcaggaaggcatttggctgcaagtaaccccaaacctacmggtgactttagaaaaaatggctttatttttcttgcattgtaagaagtcaaggggttggtgtctgctggaatggcctccactatccccttgcatggtgccagcaggaccccaggctctgtcatctttagtgtgttgacttttgttctcttgtttgtggcctcatgtcataagatggtaatcatcacttcatatgtcacctctaagtttgaggtgggaagaaggggcaggtggccaggtcagccatggtgcccttatcagtaaatcggatgccttcccagaagccctgggtagacttctttcatctcactgaccagacagtgtcacatgaccacccctagctgcgagggaagctgggaaagagggtgttttgcttttccagcctctatggaggaggaggacaagggaggggggttggaagtgggtatggggtgagccagaacatacgtctgtcacagccttgcacctggtaggcagggcaggttttttacccaatttgacagatgagaaaacagagtctgatgagttttctcgacctcaggggcaggtagagaaagaact

SEQ ID NO: 4 - protein, 455 aa, Homo sapien
MGLSTVPDLLLPLVLLELLVGIYPSGVIGLVPHLGDREKRDSVCPQGKYIHPQNNSICCTKCHKGTYLYNDCPGPGQDTDCRECESGSFTASENHLRHCLSCSKCRKEMGQVEISSCTVDRDTVCGCRKNQYRHYWSENLFQCFNCSLCLNGTVHLSCQEKQNTVCTCHAGFFLRENECVSCSNCKKSLECTKLCLPQIENVKGTEDSGTTVLLPLVIFFGLCLLSLLFIGLMYRYQRWKSKLYSIVCGKSTPEKEGELEGTTTKPLAPNPSFSPTPGFTPTLGFSPVPSSTFTSSSTYTPGDCPNFAAPRREVAPPYQGADPILATALASDPIPNPLQKWEDSAHKPQSLDTDDPATLYAVVENVPPLRWKEFVRRLGLSDHEIDRLELQNGRCLREAQYSMLATWRRRTPRREATLELLGRVLRDMDLLGCLEDIEEALCGPAALPPAPSLLR

(19) United States
(12) Patent Application Publication
(10) Pub. No.: US 2010/0331209 A1
(43) Pub. Date: Dec. 30, 2010

(54) MARKERS AND METHODS FOR ASSESSING AND TREATING SEVERE OR PERSISTANT ASTHMA AND TNF RELATED DISORDERS

(76) Inventors: Chris Huang, Radnor, PA (US); Rosemary Watt, Malvern, PA (US); Elliot Barnathan, Malvern, PA (US); Kim Hung Lo, Wayne, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/867,910

(22) PCT Filed: Mar. 19, 2009
(86) PCT No.: PCT/US09/37611

§ 371 Date: Aug. 17, 2010

Related U.S. Application Data
(60) Provisional application No. 61/037,989, filed on Mar. 19, 2008.

(51) Int. Cl. C40B 30/04; C40B 40/06

(52) U.S. Cl. 506/9; 506/16

(57) ABSTRACT

A method for assessment of the suitability of and/or effectiveness of a target therapy for a TNF-mediated-related disorder, such as severe or persistent asthma, in a subject evaluates the presence, absence, and/or magnitude of expression of one or more genes corresponding to contacting the sample with a panel of nucleic acid segments consisting of at least a portion of at least one member from the group consisting of the nucleotide sequences corresponding to at least one of TNFRSF1A SNP rs4149581 (SEQ ID NO:1), TNFRSF1 B SNP rs3766730 (SEQ ID NO:2) or TNFRSFI B SNP rs590977 (SEQ ID NO:3) SNPs which results in a determination that one or more of said SNPs in a sample are in linkage disequilibrium (LD). The method enables identification of the effectiveness of target therapies prior to or after starting a patient on such therapies.

### CROSS-REFERENCE TO RELATED APPLICATIONS

This application claims the benefit of U.S. Provisional Application No. 61/037,989, the entire contents of which are incorporated herein by reference in its entirety.

### FIELD OF THE INVENTION

The invention relates to the identification of expression profiles and the nucleic acids indicative of TNF-mediated disorders such as severe or persistent asthma, and to the use of such expression profiles and nucleic acids in diagnosis of severe or persistent asthma and related diseases. The invention further relates to methods for identifying, using, and testing candidate agents and/or targets which modulate severe or persistent asthma.

### BACKGROUND OF THE INVENTION

The treatment of severe or persistent asthma with biologics presents a number of challenges. Determining which patient population to study, predicting which subjects will respond to treatment, and which subjects will lose response following treatment are issues that have significant impact upon treatment and clinical study design. Biomarkers can be useful in answering these questions.

Biomarkers are defined as a characteristic that is objectively measured and evaluated as an indicator of normal biologic processes, pathogenic processes, or pharmacologic responses to a therapeutic intervention (Biomarkers Working Group, 2001, infra). The definition of a biomarker has recently been further defined as proteins in which a change in the expression of may correlate with an increased risk of disease or progression, or predictive of a response of a disease to a given treatment.

Tumor necrosis factor alpha (TNFα) is an important cytokine in the innate immune response, which provides immediate host defense against invading organisms before activation of the adaptive immune system. TNFα is expressed as a transmembrane precursor that undergoes proteolytic processing to form a soluble trimer. The binding of both the membrane-bound and soluble forms of TNF to its receptors, TNFRSF1A and TNFRSF1 B (also known as TNFR1 and TNFR2 respectively), initiates the expression of several other pro-inflammatory cytokines and general inflammatory markers. TNFα is a known mediator of many chronic immune-mediated inflammatory diseases.

Three biologic TNFα antagonists, infliximab (Remicade®), adalimumab (Humira®), and etanercept (Enbrel®), have been approved for patient use. Regulatory approval for a fourth biologic TNFα antagonist, namely golimumab, is currently being sought. See U.S. Pat. No. 7,250,165. The primary mechanism of these agents is to reduce the levels of TNF in the circulation thereby reducing the overall inflammation and ameliorate the clinical signs of disease, without causing systemic immunosuppression in the patient. They have been shown so far to be efficacious in treating rheumatoid arthritis (RA), psoriatic arthritis (PsA), Crohn's disease (CD), ulcerative colitis (UC), psoriasis, and ankylosing spondylitis.

Although none of these anti-TNFα agents has been approved to treat asthma, TNFα has been implicated in many aspects of the airway pathology in asthma, particularly in steroid refractory asthma. Preliminary anti-TNFα therapy studies have demonstrated an improvement in lung function, airway hyperresponsiveness and asthma quality-of-life, together with a reduction in exacerbation frequency, in patients with moderate-to-severe asthma.

However, there are individual differences in response to anti-TNF therapy and some patients do not receive therapeutic benefit. It has been hypothesized that multiple genetic variations may play a key role.

Accordingly, there is a need to identify and characterize new gene markers relevant from serum or plasma useful in developing methods for diagnosing and treating immune-mediated inflammatory disorders, such as severe or persistent asthma, as well as other diseases and conditions, and a method for predicting how a patient would respond to a therapeutic intervention.

### SUMMARY OF THE INVENTION

The present invention relates to a method of diagnosing and/or treating severe or persistent asthma and/or related diseases or disorders and predicting the suitability of candidate agents for treatment. The present invention includes the discovery of particular genes of interest that have modified expression levels in patients responsive to treatment for severe or persistent asthma (effective in reducing the symptoms of severe or persistent asthma) versus patients nonresponsive to treatment or placebo treated patients. The modified expression levels constitute a profile that can serve as a biomarker profile predictive of a patient's responsiveness to treatment and/or provide preferred dosage routes.

This invention discloses the genetic association of a set of TNFα receptor gene polymorphisms—at least one of one TNFRSF1A SNP (rs4149581) and two TNFRSF1B SNPs (rs3766730 and rs590977), e.g., at least one SNP of TNFRSF1A SNP rs4149581 (SEQ ID NO:1), TNFRSF1B SNP rs3766730 (SEQ ID NO:2) or TNFRSF1B SNP rs590977 (SEQ ID NO:3)—with therapeutic response to anti-TNFα agents (e.g., infliximab (Remicade®), adalimumab (Humira®), etanercept (Enbrel®) and golimumab), in subjects with severe, persistent asthma. There is evidence for a pharmacogenetic effect showing decreased asthma exacerbations in subjects with the common genotype (homozygotes for the major allele) in the SNPs in 2 TNF receptor genes. Because these SNPs are generally in linkage disequilibrium (LD) with other uncharacterized SNPs within these two genes, the present invention provides the ability to predict the suitability of treatment for TNF-mediated disease in subjects where at least one of TNFRSF1A SNP rs4149581 (SEQ ID NO:1), TNFRSF1B SNP rs3766730 (SEQ ID NO:2) or TNFRSF1B SNP rs590977 (SEQ ID NO:3) SNPs are found in linkage disequilibrium (LD), either with one another or other SNPs. In one embodiment, the SNPs of SEQ ID Nos. 1-3 are useful as biomarkers in identifying severe asthma subjects who are more responsive to anti-TNF therapy. In a preferred embodiment, the anti-TNF treatment is an anti-TNF antibody. In another preferred embodiment, the anti-TNF treatment is an anti-TNF agent such as etanercept. In another preferred embodiment, the anti-TNF antibody is infliximab or adalimumab. In a more preferred embodiment, the anti-TNF antibody is golimumab.

In another embodiment, the present invention uses a gene panel in a method of assessing the effectiveness of candidate agents for treatment of severe or persistent asthma or related disorders, for example, at early time points of treatment where the effectiveness of treatment may not be measurable by symptoms or traditional disease characteristics.

The provided SNPs (SEQ ID NOs. 1, 2, and/or 3) can be used to predict the suitability of treatment for a TNF-mediated disorder in a subject, by:
(a) preparing a sample of nucleic acids from a specimen obtained from a subject;
(b) contacting the sample with a panel of nucleic acid segments having at least a portion of at least one of, TNFRSF1A SNP rs4149581 (SEQ ID NO:1), TNFRSF1B SNP rs3766730 (SEQ ID NO:2) or TNFRSF1B SNP rs590977 (SEQ ID NO:3);
(c) determining whether nucleic acids from the sample exhibit single-nucleotide polymorphisms (SNPs) being in linkage disequilibrium (LD); and
(d) predicting the suitability of treatment for a TNF-mediated disorder based on the determination made in step (c).

In a particular embodiment, the present invention comprises a method of predicting the suitability of a treatment for severe or persistent asthma based on the pattern of gene expression, or the presence or absence of certain alleles, of one or more genes which are indicative of a subject's response to treatment. One or more of these genes are from a category of genes related to a set of TNFα receptor gene polymorphisms—TNFRSF1A SNP rs4149581 (SEQ ID NO:1), TNFRSF1B SNP rs3766730 (SEQ ID NO:2) or TNFRSF1B SNP rs590977 (SEQ ID NO:3). The subjects to be tested by the described methods can be any subject thought to be in need of such testing. In preferred embodiments, the subject can be selected from the group consisting of patients suspected of having severe or persistent asthma and patients diagnosed with severe or persistent asthma not undergoing treatment.

Samples for use with the described methods can be obtained from the blood or tissues of the subject to be tested. For example, the samples could be derived from a blood specimen, or components thereof, such as serum, plasma, hematocrit, white blood cells, or formed elements present in the blood. Tissue specimens could also be used to obtain test samples, for example lung biopsy, tracheal biopsy, cheek swab, and the like. Genetic elements, such as polynucleotides, that make up the panel or test sample can also be derived from genes for cytokines, chemokines, proteins involved in extracellular matrix remodeling, angiogenesis associated growth factors, a cell adhesion molecule, myeloperoxidase, and the like. Those of skill in the art will recognize that there are a number of sources from which appropriate specimens may be obtained, as the key component of both panel and test sample is genetic material, such as DNA or mRNA, which can be obtained from almost any tissue or body fluid.

In addition, the present invention comprises a method of identifying subjects with severe or persistent asthma and/or related diseases or disorders that are candidates for treatment with a particular therapeutic agent by evaluating their expression profile of one or more these TNF receptor SNPs of the panel.

In a further embodiment, the severe or persistent asthma-related gene profile is used to create an array-based method for prognostic or diagnostic purposes, the method comprising:
(a) preparing a sample of nucleic acids from a specimen obtained from a subject;
(b) contacting the sample with a panel of nucleic acid segments having at least a portion of at least one of, TNFRSF1A SNP rs4149581 (SEQ ID NO:1), TNFRSF1B SNP rs3766730 (SEQ ID NO:2) or TNFRSF1B SNP rs590977 (SEQ ID NO:3);
(c) determining whether nucleic acids from the sample exhibit single-nucleotide polymorphisms (SNPs) being in linkage disequilibrium (LD); and
(d) predicting the suitability of treatment for asthma based on the determination made in step (c).

In some embodiments it may be useful to compare the results obtained by the methods provided herein with at least one reference standard. Such a comparison may be useful to determine the type of treatment that may be most beneficial; the severity of disease, or disease progression; the degree of linkage disequilibrium among various SNPs; determine the allele, or alleles, of a gene of interest present in the genome of a subject; to determine the magnitude of change in average intensity value for each of the members of the panel between the various subjects; and the like. Reference standards may be genetic profiles derived from any source, such as from a lung biopsy, tracheal biopsy, cheek swab, serum, plasma, or other blood fraction, such as white blood cells, from a subject. The subjects from whom the reference standard samples are obtained can vary, for example the samples can be obtained from one or more subjects having mild, severe, or persistent asthma who have not been treated for the disorder, one or more subjects having mild, severe, or persistent asthma who have been treated for the disorder, one or more subjects having mild, severe, one or more subjects having mild, severe, or persistent asthma who have been treated for the disorder with a placebo, or persistent asthma who are currently being treated for the disorder, a subject responsive to treatment, or a subject that is not responsive to treatment. In addition, the reference standard sample can be obtained from the same subject from whom the test sample was obtained, such as a reference standard obtained before treatment or at an earlier treatment time point, or while undergoing a different treatment regimen. Reference standards can also be derived from specimens obtained from a biobank, or similar entity, that has or accumulates such specimens. Those of skill in the art will recognize that there are a number of sources from which appropriate reference standard samples may be obtained to produce a reference standard, as the key source of both panel and test sample is genetic material, such as DNA or mRNA, which can be obtained from almost any tissue or body fluid. The reference standards can be derived from specimens obtained from the same subject at different time points, for example reference standards could be derived from specimens obtained from the same subject before or during or after treatment; or before, during, and after treatment.

Optionally, statistical analysis is performed on the changes in levels of members of the gene SNP corresponding panel to evaluate the significance of these changes and to identify which members are meaningful members of the panel.

The determination as to whether the nucleotides assessed by the methods provided herein have SNPs that are in LD with one another or with the SNPs of SEQ ID NOs. 1, 2, and/or 3 can vary without deviating from the provided methods. For example, such a determination could be made through comparison to a reference standard where the difference in the intensity readout between the sample and the reference standard is indicative of LD, the presence of the same SNPs in the sample and a reference standard can indicate LD among SNPs. A number of software programs are available to allow for LD analyses, such as Haploview, LdCompare, PyPop, and HelixTree®, to name a few.

The described methods can also be used to determine an average intensity value for each of the nucleotides having SNPs measured. In one embodiment, the average intensity value for at least one of the SNPs tested being equal to or below the observed average for a reference standard indicates the subject will respond favorably to the treatment and the average intensity value for each of the members of the panel being above the observed average indicates the subject will respond poorly to the treatment. Alternatively, in one embodiment, the average intensity value for at least one of the SNPs tested being equal to or higher than the observed average for a reference standard indicates the subject will respond favorably to the treatment and the average intensity value for each of the members of the panel being below the observed average indicates the subject will respond poorly to the treatment. In some embodiments, one or more of the nucleotide sequences to be tested can be analyzed by sequence analysis to obtain a more detailed, or alternate, assessment of the nucleotide sequences. In another embodiment, one or more of the nucleotide sequences to be tested can be analyzed by mass spectrometry, which can be helpful in determining aspects of sequence composition, methylation state, and the like.

In an alternative embodiment, the present invention comprises a kit for predicting the suitability of candidate agents for treating severe or persistent asthma and/or related diseases or disorders based on the pattern of gene expression. In some embodiments, this kit can include any, or all, of the following: oligonucleotides the same as, or complementary to, the nucleotide sequence of a marker gene, or the complementary strand thereof; cells expressing the marker gene, wherein the marker gene is selected from the group consisting of the nucleotide sequences of at least one of, TNFRSF1A SNP rs4149581 (SEQ ID NO: 1), TNFRSF1B SNP rs3766730 (SEQ ID NO: 2) or TNFRSF1B SNP rs590977 (SEQ ID NO: 3) SNPs; SNPs known to be in LD with the one, or more, of TNFRSF1A SNP rs4149581 (SEQ ID NO: 1), TNFRSF1B SNP rs3766730 (SEQ ID NO: 2) or TNFRSF1B SNP rs590977 (SEQ ID NO: 3); and a nucleotide array panel having at least TNFRSF1A SNP rs4149581 (SEQ ID NO: 1), TNFRSF1B SNP rs3766730 (SEQ ID NO: 2) or TNFRSF1B SNP rs590977 (SEQ ID NO: 3)v.

The present invention further provides any invention described herein.

### DETAILED DESCRIPTION OF THE INVENTION

### Definitions

The following definitions are set forth to illustrate and define the meaning and scope of various terms used to describe the invention herein.

An “activity,” a biological activity, and a functional activity of a polypeptide refers to an activity exerted by a gene of the severe or persistent asthma-related gene panel in response to its specific interaction with another protein or molecule as determined in vivo, in situ, or in vitro, according to standard techniques. Such activities can be a direct activity, such as an association with or an enzymatic activity on a second protein, or an indirect activity, such as a cellular process mediated by interaction of the protein with a second protein or a series of interactions as in intracellular signaling or the coagulation cascade.

An “antibody” includes any polypeptide or peptide containing molecule that comprises at least a portion of an immunoglobulin molecule, such as but not limited to, at least one complementarity determining region (CDR) of a heavy or light chain or a ligand binding portion thereof, a heavy chain or light chain variable region, a heavy chain or light chain constant region, a framework region, or any portion, fragment or variant thereof. The term “antibody” is further intended to encompass antibodies, digestion fragments, specified portions and variants thereof, including antibody mimetics or comprising portions of antibodies that mimic the structure and/or function of an antibody or specified fragment or portion thereof, including single chain antibodies and fragments thereof. For example, antibody fragments include, but are not limited to, Fab (e.g., by papain digestion), Fab′ (e.g., by pepsin digestion and partial reduction) and F(ab′)2 (e.g., by pepsin digestion), facb (e.g., by plasmin digestion), pFc' (e.g., by pepsin or plasmin digestion), Fd (e.g., by pepsin digestion, partial reduction and reaggregation), Fv or scFv (e.g., by molecular biology techniques) fragments, and single domain antibodies (e.g., V_{H} or V_{L}), are encompassed by the invention (see, e.g., Colligan, et al., eds., Current Protocols in Immunology, John Wiley & Sons, Inc., NY (1994-2001); Colligan et al., Current Protocols in Polypeptide Science, John Wiley & Sons, NY (1997-2001)).

The terms “array” or “microarray” or “biochip” or “chip” as used herein refer to articles of manufacture or devices comprising a plurality of immobilized target elements, each target element comprising a “clone,” “feature,” “spot” or defined area comprising a particular composition, such as a biological molecule, e.g., a nucleic acid molecule or polypeptide, immobilized to a solid surface, as discussed in further detail, below.

“Complement of” or “complementary to” a nucleic acid sequence of the invention refers to a polynucleotide molecule having a complementary base sequence and reverse orientation as compared to a first polynucleotide.

“Identity,” as known in the art, is a relationship between two or more polypeptide sequences or two or more polynucleotide sequences, as determined by comparing the sequences. In the art, “identity” also means the degree of sequence relatedness between polypeptide or polynucleotide sequences, as determined by the match between strings of such sequences. “Identity” and “similarity” can be readily calculated by known methods, including, but not limited to, those described in Computational Molecular Biology, Lesk, A. M., ed., Oxford University Press, New York, 1988; Biocomputing: Informatics and Genome Projects, Smith, D. W., ed., Academic Press, New York, 1993; Computer Analysis of Sequence Data, Part I, Griffin, A. M., and Griffin, H. G., eds., Humana Press, New Jersey, 1994; Sequence Analysis in Molecular Biology, von Heinje, G., Academic Press, 1987; and Sequence Analysis Primer, Gribskov, M. and Devereux, J., eds., M Stockton Press, New York, 1991; and Carillo, H., and Lipman, D., Siam J. Applied Math., 48:1073 (1988). In addition, values for percentage identity can be obtained from amino acid and nucleotide sequence alignments generated using the default settings for the AlignX component of Vector NTI Suite 8.0 (Informax, Frederick, Md.).

The terms “specifically hybridize to,” “hybridizing specifically to,” “specific hybridization” and “selectively hybridize to,” as used herein refer to the binding, duplexing, or hybridizing of a nucleic acid molecule preferentially to a particular nucleotide sequence under stringent conditions. The term “stringent conditions” refers to conditions under which a probe will hybridize preferentially to its target subsequence; and to a lesser extent to, or not at all to, other sequences. A “stringent hybridization” and “stringent hybridization wash conditions” in the context of nucleic acid hybridization (e.g., as in array, Southern or Northern hybridizations) are sequence dependent, and are different under different environmental parameters. Alternative hybridization conditions that can be used to practice the invention are described in detail, below. In alternative aspects, the hybridization and/or wash conditions are carried out under moderate conditions, stringent conditions and very stringent conditions, as described in further detail, below. Alternative wash conditions are also used in different aspects, as described in further detail, herein.

The phrases “labeled biological molecule” or “labeled with a detectable composition” or “labeled with a detectable moiety” as used herein refer to a biological molecule, e.g., a nucleic acid, comprising a detectable composition, i.e., a label, as described in detail, below. The label can also be another biological molecule, as a nucleic acid, e.g., a nucleic acid in the form of a stem-loop structure as a “molecular beacon,” as described below. This includes incorporation of labeled bases (or, bases which can bind to a detectable label) into the nucleic acid by, e.g., nick translation, random primer extension, amplification with degenerate primers, and the like. Any label can be used, e.g., chemiluminescent labels, radiolabels, enzymatic labels and the like. The label can be detectable by any means, e.g., visual, spectroscopic, photochemical, biochemical, immunochemical, physical, chemical and/or chemiluminescent detection. The invention can use arrays comprising immobilized nucleic acids comprising detectable labels.

The term “nucleic acid” as used herein refers to a deoxyribonucleotide (DNA) or ribonucleotide (RNA) in either single- or double-stranded form. The term encompasses nucleic acids containing known analogues of natural nucleotides. The term nucleic acid is used interchangeably with gene, DNA, RNA, cDNA, mRNA, oligonucleotide primer, probe and amplification product. The term also encompasses DNA backbone analogues, such as phosphodiester, phosphorothioate, phosphorodithioate, methylphosphonate, phosphoramidate, alkyl phosphotriester, sulfamate, 3′-thioacetal, methylene (methylimino), 3′-N-carbamate, morpholino carbamate, and peptide nucleic acids (PNAs).

The terms “sample” or “sample of nucleic acids” as used herein refer to a sample comprising a DNA or RNA, or nucleic acid representative of DNA or RNA isolated from a natural source. A “sample of nucleic acids” is in a form suitable for hybridization (e.g., as a soluble aqueous solution) to another nucleic acid (e.g., immobilized probes). The sample nucleic acid can be isolated, cloned, or extracted from particular cells or tissues. The cell or tissue sample from which the nucleic acid sample is prepared is typically taken from a patient having or suspected of having UC or a related disease or condition. Methods of isolating cell and tissue samples are well known to those of skill in the art and include, but are not limited to, aspirations, tissue sections, needle biopsies, and the like. Frequently the sample will be a “clinical sample” which is a sample derived from a patient, including sections of tissues such as frozen sections or paraffin sections taken for histological purposes. The sample can also be derived from supernatants (of cells) or the cells themselves taken from patients or from cell cultures, cells from tissue culture and other media in which it can be desirable to detect the response to drug candidates. In some cases, the nucleic acids can be amplified using standard techniques such as PCR, prior to the hybridization. The probe an be produced from and collectively can be representative of a source of nucleic acids from one or more particular (pre-selected) portions of, e.g., a collection of polymerase chain reaction (PCR) amplification products, substantially an entire chromosome or a chromosome fragment, or substantially an entire genome, e.g., as a collection of clones, e.g., BACs, PACs, YACs, and the like (see below).

“Nucleic acids” are polymers of nucleotides, wherein a nucleotide comprises a base linked to a sugar which sugars are in turn linked one to another by an interceding at least bivalent molecule, such as phosphoric acid. In naturally occurring nucleic acids, the sugar is either 2′-deoxyribose (DNA) or ribose (RNA). Unnatural poly- or oligonucleotides contain modified bases, sugars, or linking molecules, but are generally understood to mimic the complementary nature of the naturally occurring nucleic acids after which they are designed. An example of an unnatural oligonucleotide is an antisense molecule composition that has a phosphorothiorate backbone. An “oligonucleotide” generally refers to a nucleic acid molecule having less than 30 nucleotides.

The term “profile” means a pattern and relates to the magnitude and direction of change of a number of features. The profile can be interpreted stringently, i.e., where the variation in the magnitude and/or number of features within the profile displaying the characteristic is substantially similar to a reference profile or it can be interpreted less stringently, for example, by requiring a trend rather than an absolute match of all or a subset of feature characteristics.

The terms “protein,” “polypeptide,” and “peptide” include “analogs,” or “conservative variants” and “mimetics” or “peptidomimetics” with structures and activity that substantially correspond to the polypeptide from which the variant was derived, as discussed in detail above.

A “polypeptide” is a polymer of amino acid residues joined by peptide bonds, and a peptide generally refers to amino acid polymers of 12 or less residues. Peptide bonds can be produced naturally as directed by the nucleic acid template or synthetically by methods well known in the art.

A “protein” is a macromolecule comprising one or more polypeptide chains. A protein may further comprise substituent groups attached to the side groups of the amino acids not involved in formation of the peptide bonds. Typically, proteins formed by eukaryotic cell expression also contain carbohydrates. Proteins are defined herein in terms of their amino acid sequence or backbone and substituents are not specified, whether known or not.

The term “receptor” denotes a molecule having the ability to affect biological activity, in e.g., a cell, as a result of interaction with a specific ligand or binding partner. Cell membrane bound receptors are characterized by an extracellular ligand-binding domain, one or more membrane spanning or transmembrane domains, and an intracellular effector domain that is typically involved in signal transduction. Ligand binding to cell membrane receptors causes changes in the extracellular domain that are communicated across the cell membrane, direct or indirect interaction with one or more intracellular proteins, and alters cellular properties, such as enzyme activity, cell shape, or gene expression profile. Receptors may also be untethered to the cell surface and can be cytosolic, nuclear, or released from the cell altogether. Non-cell associated receptors are termed soluble receptors or ligands.

The term “TNF-mediated” is used broadly and includes alternative levels of association, such as TNF-related and TNF-associated, and also encompasses processes directly or indirectly mediated by TNF.

| Biomarker Abbreviation | Full Name |
|---|---|
| TNFα | Tumor necrosis factor alpha |

All publications or patents cited herein are entirely incorporated herein by reference, whether or not specifically designated accordingly, as they show the state of the art at the time of the present invention and/or provide description and enablement of the present invention. Publications refer to any scientific or patent publications, or any other information available in any media format, including all recorded, electronic or printed formats. The following references are entirely incorporated herein by reference: Ausubel, et al., ed., Current Protocols in Molecular Biology, John Wiley & Sons, Inc., NY (1987-2008); Sambrook, et al., Molecular Cloning: A Laboratory Manual, 2nd Edition, Cold Spring Harbor, N.Y. (1989); Harlow and Lane, antibodies, a Laboratory Manual, Cold Spring Harbor, N.Y. (1989); Colligan, et al., eds., Current Protocols in Immunology, John Wiley & Sons, Inc., NY (1994-2008); Colligan et al., Current Protocols in Protein Science, John Wiley & Sons, NY (1997-2008).

### Gene Panel Identification and Validation

The present invention provides novel methods for screening for compositions which modulate the symptoms of severe or persistent asthma. This invention discloses the genetic association of a set of TNFα receptor gene polymorphisms—at least one of one TNFRSF1A SNP (rs4149581 (SEQ ID NO: 1)) and two TNFRSF1B SNPs (rs3766730 (SEQ ID NO: 2) and rs590977 (SEQ ID NO: 3))—with therapeutic response to anti-TNFα agents (e.g., golimumab), in subjects with severe, persistent asthma. There is evidence for a pharmacogenetic effect showing decreased asthma exacerbations in subjects with the common genotype (homozygotes for the major allele) in the SNPs in 2 TNF receptor genes. Because these SNPs are generally in linkage disequilibrium (LD) with other uncharacterized SNPs within these two genes, the present invention provides where the presence of one or more, or at least one of, TNFRSF1A SNP rs4149581 (SEQ ID NO:1), TNFRSF1B SNP rs3766730 (SEQ ID NO:2) or TNFRSF1B SNP rs590977 (SEQ ID NO:3) SNPs in linkage disequilibrium (LD) are useful as biomarkers in identifying severe asthma subjects who are more responsive to anti-TNF therapy.

The identification of these TNFR SNP sequences (genes or hereinafter “severe or persistent asthma-related gene sequences”) that are differentially expressed in disease tissue allows the use of this information in a number of ways. For example, the evaluation of a particular treatment regime can be evaluated. This can be done by making biochips comprising sets of complementary sequences to these TNFR SNP sequences, which can then be used to identify these sequences in a biological sample, such as a sample from a patient. These methods can also be performed on the protein level; that is, protein expression levels of the severe or persistent asthma-related TNFR SNP products can be evaluated for diagnostic purposes or to select anti-TNF treatment or to screen additional candidate therapeutics. In addition, the nucleic acid sequences comprising the severe or persistent asthma-related gene profile can be used to measure whether a patient is likely to respond to a therapeutic prior to treatment.

Severe or persistent asthma-related gene sequences can include both nucleic acid and amino acid sequences. In a preferred embodiment, the severe or persistent asthma-related gene sequences are recombinant nucleic acids. By the term “recombinant nucleic acid” herein is meant nucleic acid, originally formed in vitro, in general, by the manipulation of nucleic acid by polymerases and endonucleases, in a form not normally found in nature. Thus, an isolated nucleic acid, in a linear form, or an expression vector formed in vitro by ligating DNA molecules that are not normally joined, are both considered recombinant for the purposes of this invention. It is understood that once a recombinant nucleic acid is made and reintroduced into a host cell or organism, it will replicate non-recombinantly, i.e., using the in vivo cellular machinery of the host cell rather than in vitro manipulations; however, such nucleic acids, once produced recombinantly, although subsequently replicated non-recombinantly, are still considered recombinant for the purposes of the invention.

### Method of Practicing the Invention

The invention provides in vitro, in situ, or in silico, nucleic acid, protein and/or array-based methods relying on the relative amount of a binding molecule (e.g., nucleic acid sequence) in two or more samples. Also provided are computer-implemented methods for determining the relative amount of a binding molecule (e.g., nucleic acid sequence) in two or more samples and using the determined relative binding amount to predict responsiveness to a particular therapy, and monitor and enhance therapeutic treatment.

In practicing the methods of the invention, one or more samples of labeled biological molecules (e.g., nucleic acid) are applied to two or more assays or arrays, where the assays or arrays have substantially the same complement of immobilized binding molecule (e.g., immobilized nucleic acid capable of hybridizing to labeled sample nucleic acid). The two or more arrays are typically multiple copies of the same array. However, because each “spot,” “clone” or “feature” on the array has similar biological molecules (e.g., nucleic acids of the same sequence) and the biological molecules (e.g., nucleic acid) in each spot is known, as is typical of nucleic acid and other arrays, it is not necessary that the multiple arrays used in the invention be identical in configuration it is only necessary that the position of each feature on the substrate be known, that is, have an address. Thus, in one aspect, multiple biological molecules (e.g., nucleic acid) in samples are comparatively bound to the array (e.g., hybridized simultaneously) and the information gathered is coded so that the results are based on the inherent properties of the feature (e.g., the nucleic acid sequence) and not it's position on the substrate.

### Amplification of Nucleic Acids

Well known methods of nucleic acid amplification using oligonucleotide primers can be used to generate nucleic acids used in the compositions and methods of the invention, to detect or measure levels of test or control samples hybridized to an array, and the like, e.g., to detect the presence of TNFR SNPs of the present invention. The skilled artisan can select and design suitable oligonucleotide amplification primers. Amplification methods are also well known in the art, and include, e.g., polymerase chain reaction, PCR (PCR PROTOCOLS, A GUIDE TO METHODS AND APPLICATIONS, ed. Innis, Academic Press, N.Y. (1990) and PCR STRATEGIES (1995), ed. Innis, Academic Press, Inc., N.Y., ligase chain reaction (LCR) (see, e.g., Wu (1989) Genomics 4:560; Landegren (1988) Science 241:1077; Barringer (1990) Gene 89:117); transcription amplification (see, e.g., Kwoh (1989) Proc. Natl. Acad. Sci. USA 86:1173); and, self-sustained sequence replication (see, e.g., Guatelli (1990) Proc. Natl. Acad. Sci. USA 87:1874); Q Beta replicase amplification (see, e.g., Smith (1997) J. Clin. Microbiol. 35:1477-1491), automated Q-beta replicase amplification assay (see, e.g., Burg (1996) Mol. Cell. Probes 10:257-271) and other RNA polymerase mediated techniques (e.g., NASBA, Cangene, Mississauga, Ontario); see also Berger (1987) Methods Enzymol. 152:307-316; Sambrook; Ausubel; U.S. Pat. Nos. 4,683,195 and 4,683,202; Sooknanan (1995) Biotechnology 13:563-564.

### Hybridizing Nucleic Acids

In practicing the methods of the invention, test and control samples of nucleic acid are hybridized to immobilized probe nucleic acid, e.g., on arrays. In alternative aspects, the hybridization and/or wash conditions are carried out under moderate conditions, stringent conditions and very stringent conditions. An extensive guide to the hybridization of nucleic acids is found in, e.g., Sambrook Ausubel, Tijssen. Generally, highly stringent hybridization and wash conditions are selected to be about 5° C. lower than the thermal melting point (Tm) for the specific sequence at a defined ionic strength and pH. The Tm is the temperature (under defined ionic strength and pH) at which 50% of the target sequence hybridizes to a perfectly matched probe. Very stringent conditions are selected to be equal to the Tm for a particular probe. An example of stringent hybridization conditions for hybridization of complementary nucleic acids which have more than 100 complementary residues on an array or a filter in a Southern or northern blot is 42° C. using standard hybridization solutions (see, e.g., Sambrook), with the hybridization being carried out overnight. An example of highly stringent wash conditions is 0.15 M NaCl at 72° C. for about 15 minutes. An example of stringent wash conditions is a 0.2×SSC wash at 65° C. for 15 minutes (see, e.g., Sambrook). Often, a high stringency wash is preceded by a medium or low stringency wash to remove background probe signal. An example medium stringency wash for a duplex of, e.g., more than 100 nucleotides, is 1×SSC at 45° C. for 15 minutes. An example of a low stringency wash for a duplex of, e.g., more than 100 nucleotides, is 4× to 6×SSC at 40° C. for 15 minutes.

In alternative aspects of the compositions and methods of the invention, e.g., in practicing comparative nucleic acid hybridization, such as comparative genomic hybridization (CGH) with arrays, the fluorescent dyes Cy3® and Cy5® are used to differentially label nucleic acid fragments from two samples, e.g., the array-immobilized nucleic acid versus the sample nucleic acid, or, nucleic acid generated from a control versus a test cell or tissue. Many commercial instruments are designed to accommodate the detection of these two dyes. To increase the stability of Cy5®, fluorescent dyes, or other oxidation-sensitive compounds, antioxidants and free radical scavengers can be used in hybridization mixes, the hybridization and/or the wash solutions. Thus, Cy5® signals are dramatically increased and longer hybridization times are possible. See WO 0194630 A2 and U.S. Patent Application No. 20020006622.

To further increase the hybridization sensitivity, hybridization can be carried out in a controlled, unsaturated humidity environment; thus, hybridization efficiency is significantly improved if the humidity is not saturated. See WO 0194630 A2 and U.S. Patent Application No. 20020006622. The hybridization efficiency can be improved if the humidity is dynamically controlled, i.e., if the humidity changes during hybridization. Mass transfer will be facilitated in a dynamically balanced humidity environment. The humidity in the hybridization environment can be adjusted stepwise or continuously. Array devices comprising housings and controls that allow the operator to control the humidity during pre-hybridization, hybridization, wash and/or detection stages can be used. The device can have detection, control and memory components to allow pre-programming of the humidity and temperature controls (which are constant and precise or which fluctuate), and other parameters during the entire procedural cycle, including pre-hybridization, hybridization, wash and detection steps. See WO 0194630 A2 and U.S. Patent Application No. 20020006622.

The methods of the invention can comprise hybridization conditions comprising osmotic fluctuation. Hybridization efficiency (i.e., time to equilibrium) can also be enhanced by a hybridization environment that comprises changing hyper-/hypo-tonicity, e.g., a solute gradient. A solute gradient is created in the device. For example, a low salt hybridization solution is placed on one side of the array hybridization chamber and a higher salt buffer is placed on the other side to generate a solute gradient in the chamber. See WO 0194630 A2 and U.S. Patent Application No. 20020006622.

### Blocking the Ability of Repetitive Nucleic Acid Sequences to Hybridize

The methods of the invention can comprise a step of blocking the ability of repetitive nucleic acid sequences to hybridize (i.e., blocking “hybridization capacity”) in the immobilized nucleic acid segments. The hybridization capacity of repetitive nucleic acid sequences in the sample nucleic acid sequences can be blocked by mixing sample nucleic acid sequences with unlabeled or alternatively labeled repetitive nucleic acid sequences. Sample nucleic acid sequences can be mixed with repetitive nucleic acid sequences before the step of contacting with the array-immobilized nucleic acid segments. Blocking sequences are for example, Cot-1 DNA, salmon sperm DNA, or specific repetitive genomic sequences. The repetitive nucleic acid sequences can be unlabeled. A number of methods for removing and/or disabling the hybridization capacity of repetitive sequences using, e.g., Cot-1 are known; see, e.g., Craig (1997) Hum. Genet. 100:472-476; WO 93/18186. Repetitive DNA sequences can be removed from library probes by means of magnetic purification and affinity PCR, see, e.g., Rauch (2000) J. Biochem. Biophys. Methods 44:59-72.

Arrays are generically a plurality of target elements immobilized onto the surface of the plate as defined “spots” or “clusters,” or “features,” with each target element comprising one or more biological molecules (e.g., nucleic acids or polypeptides) immobilized to a solid surface for specific binding (e.g., hybridization) to a molecule in a sample. The immobilized nucleic acids can contain sequences from specific messages (e.g., as cDNA libraries) or genes (e.g., genomic libraries), including a human genome. Other target elements can contain reference sequences and the like. The biological molecules of the arrays can be arranged on the solid surface at different sizes and different densities. The densities of the biological molecules in a cluster and the number of clusters on the array will depend upon a number of factors, such as the nature of the label, the solid support, the degree of hydrophobicity of the substrate surface, and the like. Each feature may comprise substantially the same biological molecule (e.g., nucleic acid), or, a mixture of biological molecules (e.g., nucleic acids of different lengths and/or sequences). Thus, for example, a feature may contain more than one copy of a cloned piece of DNA, and each copy can be broken into fragments of different lengths.

Array substrate surfaces onto which biological molecules (e.g., nucleic acids) are immobilized can include nitrocellulose, glass, quartz, fused silica, plastics and the like, as discussed further, below. The compositions and methods of the invention can incorporate in whole or in part designs of arrays, and associated components and methods, as described, e.g., in U.S. Pat. Nos. 6,344,316; 6,197,503; 6,174,684; 6,159,685; 6,156,501; 6,093,370; 6,087,112; 6,087,103; 6,087,102; 6,083,697; 6,080,585; 6,054,270; 6,048,695; 6,045,996; 6,022,963; 6,013,440; 5,959,098; 5,856,174; 5,843,655; 5,837,832; 5,770,456; 5,723,320; 5,700,637; 5,695,940; 5,556,752; 5,143,854; see also, e.g., WO 99/51773; WO 99/09217; WO 97/46313; WO 96/17958; WO 89/10977; see also, e.g., Johnston (1998) Curr. Biol. 8:R171-174; Schummer (1997) Biotechniques 23:1087-1092; Kern (1997) Biotechniques 23:120-124; Solinas-Toldo (1997) Genes, Chromosomes & Cancer 20:399-407; Bowtell (1999) Nature Genetics Supp. 21:25-32; Epstein (2000) Current Opinion in Biotech. 11:36-41; Mendoza (1999 Biotechniques 27: 778-788; Lueking (1999) Anal. Biochem. 270:103-111; Davies (1999) Biotechniques 27:1258-1261.

### Substrate Surfaces

Substrate surfaces that can be used in the compositions and methods of the invention include, for example, glass (see, e.g., U.S. Pat. No. 5,843,767), ceramics, and quartz. The arrays can have substrate surfaces of a rigid, semi-rigid or flexible material. The substrate surface can be flat or planar, be shaped as wells, raised regions, etched trenches, pores, beads, filaments, or the like. Substrate surfaces can also comprise various materials such as nitrocellulose, paper, crystalline substrates (e.g., gallium arsenide), metals, metalloids, polacryloylmorpholide, various plastics and plastic copolymers, Nylon®, Teflon®, polyethylene, polypropylene, latex, polymethacrylate, poly (ethylene terephthalate), rayon, nylon, poly(vinyl butyrate), and cellulose acetate. The substrates can be coated and the substrate and the coating can be functionalized to, e.g., enable conjugation to an amine.

### Arrays Comprising Calibration Sequences

The invention contemplates the use of arrays comprising immobilized calibration sequences for normalizing the results of array-based hybridization reactions, and methods for using these calibration sequences, e.g., to determine the copy number of a calibration sequence to “normalize” or “calibrate” ratio profiles. The calibration sequences can be substantially the same as a unique sequence in an immobilized nucleic acid sequence on an array. For example, a “marker” sequence from each “spot” or “biosite” on an array (which is present only on that spot, making it a “marker” for that spot) is represented by a corresponding sequence on one or more “control” or “calibration” spot(s).

The “control spots” or “calibration spots” are used for “normalization” to provide information that is reliable and repeatable. Control spots can provide a consistent result independent of the labeled sample hybridized to the array (or a labeled binding molecule from a sample). The control spots can be used to generate a “normalization” or “calibration” curve to offset possible intensity errors between the two arrays (or more) used in the in silico, array-based methods of the invention.

One method of generating a control on the array would be to use an equimolar mixture of all the biological molecules (e.g., nucleic acid sequences) spotted on the array and generating a single spot. This single spot would have equal amounts of the biological molecules (e.g., nucleic acid sequences) from all the other spots on the array. Multiple control spots can be generated by varying the concentration of the equimolar mixture.

### Samples and Specimens

The sample nucleic acid can be isolated, cloned, or extracted from particular cells, tissues, or other specimens. The cell or tissue sample from which the nucleic acid sample is prepared is typically taken from a patient having or suspected of having severe or persistent asthma or a related condition. Methods of isolating cell and tissue samples are well known to those of skill in the art and include, but are not limited to, aspirations, tissue sections, needle biopsies, and the like. Frequently, the sample will be a “clinical sample” which is a sample derived from a patient, including whole blood, serum, plasma, or sections of tissues, such as frozen sections or paraffin sections taken for histological purposes. The sample can also be derived from supernatants (of cells) or the cells themselves taken from patients or from cell cultures, cells from tissue culture and other media in which it can be desirable to detect the response to drug candidates. In some cases, the nucleic acids can be amplified using standard techniques such as PCR, prior to the hybridization.

In one embodiment, the present invention is a pre-treatment method of predicting disease regression or resolution. The method includes (1) taking a suitable tissue biopsy or other specimen from an individual diagnosed with severe or persistent asthma or a related disease or disorder, (2) measuring the expression levels of the profile genes of the panel, (3) comparing the pre-treatment expression level of the genes with a pre-treatment reference profile from treatment responders, and (4) predicting treatment response by monitoring the expression levels of the gene panel.

### Methods of Assessing Biomarker Utility

The prognostic utility of the present biomarker gene panel for assessing a patient's response to treatment or prognosis of disease can be validated by using other means for assessing a patient's state of disease. For example, gross measurement of disease can be assessed and recorded by certain imaging methods, such as but not limited to: imaging by photographic, radiometric, or magnetic resonance technology. General indices of health or disease further include serum or blood composition (protein, liver enzymes, pH, electrolytes, red cell volume, hematocrit, hemoglobin, or specific protein). However, in some diseases, the etiology is still poorly understood. Severe or persistent asthma is an example of one such disease.

### Patient Assessment and Monitoring

The expression patterns of the genes over the course of treatment have not been studied in the treatment of severe or persistent asthma, and none has been identified as having predictive value. The panel of gene expression biomarkers disclosed herein permits the generation of methods for rapid and reliable prediction, diagnostic tools that predict the clinical outcome of a severe or persistent asthma trial, or prognostic tools for tracking the efficacy of severe or persistent asthma therapy. Prognostic methods based on detecting these genes in a sample are provided. These methods can be used, for example, in connection with the diagnosis, prevention and treatment of a range of immune-mediated inflammatory diseases, especially those associated with TNF.

### Therapeutic Agents

As used herein, the term “antagonists” refer to substances which inhibit or neutralize the biologic activity of the gene product of the severe or persistent asthma-related gene panel of the invention. Such antagonists accomplish this effect in a variety of ways. One class of antagonists will bind to the gene product protein with sufficient affinity and specificity to neutralize the biologic effects of the protein. Included in this class of molecules are antibodies and antibody fragments (such as, for example, F(ab) or F(ab′)₂ molecules). Another class of antagonists comprises fragments of the gene product protein, muteins or small organic molecules, i.e., peptidomimetics, that will bind to the cognate binding partners or ligands of the gene product, thereby inhibiting the biologic activity of the specific interaction of the gene product with its cognate ligand or receptor. The severe or persistent asthma-related gene antagonist can be of any of these classes as long as it is a substance that inhibits at least one biological activity of the gene product.

Antagonists include antibodies directed to one or more regions of the gene product protein or fragments thereof, antibodies directed to the cognate ligand or receptor, and partial peptides of the gene product or its cognate ligand which inhibit at least one biological activity of the gene product. Another class of antagonists includes siRNAs, shRNAs, antisense molecules and DNAzymes targeting the gene sequence as known in the art are disclosed herein.

Suitable antibodies include those that compete for binding to severe or persistent asthma-related gene products with monoclonal antibodies that block severe or persistent asthma-related gene product activation or prevent asthma-related gene product binding to its cognate ligand, or prevent severe or persistent asthma-related gene product signaling.

A therapeutic targeting the inducer of the severe or persistent asthma-related gene product may provide better chances of success. Gene expression can be modulated in several different ways including by the use of siRNAs, shRNAs, antisense molecules and DNAzymes. Synthetic siRNAs, shRNAs, and DNAzymes can be designed to specifically target one or more genes and they can easily be delivered to cells in vitro or in vivo.

The present invention encompasses antisense nucleic acid molecules, i.e., molecules that are complementary to a sense nucleic acid encoding a severe or persistent asthma-related gene product polypeptide, e.g., complementary to the coding strand of a double-stranded cDNA molecule or complementary to an mRNA sequence. Accordingly, an antisense nucleic acid can hydrogen bond to a sense nucleic acid. The antisense nucleic acid can be complementary to an entire coding strand, or to only a portion thereof, e.g., all or part of the protein coding region (or open reading frame). An antisense nucleic acid molecule can be antisense to all or part of a non-coding region of the coding strand of a nucleotide sequence encoding a severe or persistent asthma-related gene product polypeptide. The non-coding regions (“5′ and 3′ untranslated regions”) are the 5′ and 3′ sequences that flank the coding region and are not translated into amino acids.

The invention also provides chimeric or fusion proteins. As used herein, a “chimeric protein” or “fusion protein” comprises all or part (preferably biologically active) of a severe or persistent asthma-related gene product polypeptide operably linked to a heterologous polypeptide (i.e., a polypeptide other than the same UC-related gene product polypeptide). Within the fusion protein, the term “operably linked” is intended to indicate that the severe or persistent asthma-related gene product polypeptide and the heterologous polypeptide are fused in-frame to each other. The heterologous polypeptide can be fused to the amino-terminus or the carboxyl-terminus of the severe or persistent asthma-related gene product polypeptide. In another embodiment, a severe or persistent asthma-related gene product polypeptide or a domain or active fragment thereof can be fused with a heterologous protein sequence or fragment thereof to form a chimeric protein, where the polypeptides, domains or fragments are not fused end to end but are interposed within the heterologous protein framework.

In yet another embodiment, the fusion protein is an immunoglobulin fusion protein in which all or part of a severe or persistent asthma-related gene product polypeptide is fused to sequences derived from a member of the immunoglobulin protein family. The immunoglobulin fusion proteins of the invention can be incorporated into pharmaceutical compositions and administered to a subject to inhibit an interaction between a ligand (soluble or membrane-bound) and a protein on the surface of a cell (receptor), to thereby suppress signal transduction in vivo. The immunoglobulin fusion protein can be used to affect the bioavailability of a cognate ligand of a severe or persistent asthma-related gene product polypeptide. Inhibition of ligand/receptor interaction can be useful therapeutically, both for treating proliferative and differentiative disorders and for modulating (e.g., promoting or inhibiting) cell survival. Moreover, the immunoglobulin fusion proteins of the invention can be used as immunogens to produce antibodies directed against a severe or persistent asthma-related gene product polypeptide in a subject, to purify ligands and in screening assays to identify molecules that inhibit the interaction of receptors with ligands.

### Compositions and Their Uses

In accordance with the invention, the neutralizing anti-severe or persistent asthma-related gene product antagonists, such as monoclonal antibodies, described herein can be used to inhibit severe or persistent asthma-related gene product activity. Additionally, such antagonists can be used to inhibit the pathogenesis of severe or persistent asthma and related inflammatory diseases amenable to such treatment, which may include, but are not limited to, rheumatic diseases. The individual to be treated can be any mammal and is preferably a primate, a companion animal which is a mammal and most preferably a human patient. The amount of antagonist administered will vary according to the purpose it is being used for and the method of administration.

The severe or persistent asthma-related gene product antagonists can be administered by any number of methods that result in an effect in tissue in which pathological activity is desired to be prevented or halted. Further, the anti-severe or persistent asthma-related gene product antagonists need not be present locally to impart an effect on the severe or persistent asthma-related gene product activity, therefore, they can be administered wherever access to body compartments or fluids containing severe or persistent asthma-related gene product is achieved. In the case of inflamed, malignant, or otherwise compromised tissues, these methods may include direct application of a formulation containing the antagonists. Such methods include intravenous administration of a liquid composition, transdermal administration of a liquid or solid formulation, oral, topical administration, or interstitial or inter-operative administration. Administration can be affected by the implantation of a device whose primary function may not be as a drug delivery vehicle.

For antibodies, the preferred dosage is about 0.1 mg/kg to 100 mg/kg of body weight (generally about 10 mg/kg to 20 mg/kg). If the antibody is to act in the brain, a dosage of about 50 mg/kg to 100 mg/kg is usually appropriate. Generally, partially human antibodies and fully human antibodies have a longer half-life within the human body than other antibodies. Accordingly, the use of lower dosages and less frequent administration is often possible. Modifications, such as lipidation, can be used to stabilize antibodies and to enhance uptake and tissue penetration (e.g., into the brain). A method for lipidation of antibodies is described by Cruikshank et al. ((1997) J. Acquired Immune Deficiency Syndromes and Human Retrovirology 14:193).

The severe or persistent asthma-related gene product antagonist nucleic acid molecules can be inserted into vectors and used as gene therapy vectors. Gene therapy vectors can be delivered to a subject by, for example, intravenous injection, local administration (U.S. Pat. No. 5,328,470), or by stereotactic injection (see, e.g., Chen et al. (1994) Proc. Natl. Acad. Sci. USA 91:3054-3057). The pharmaceutical preparation of the gene therapy vector can include the gene therapy vector in an acceptable diluent, or can comprise a slow release matrix in which the gene delivery vehicle is imbedded. Alternatively, where the complete gene delivery vector can be produced intact from recombinant cells, e.g., retroviral vectors, the pharmaceutical preparation can include one or more cells which produce the gene delivery system.

The pharmaceutical compositions can be included in a container, pack, or dispenser together with instructions for administration.

### Pharmacogenomics

Agents, or modulators that have a stimulatory or inhibitory effect on activity or expression of a severe or persistent asthma-related gene product polypeptide as identified by a screening assay described herein, can be administered to individuals to treat (prophylactically or therapeutically) disorders associated with aberrant activity of the polypeptide. In conjunction with such treatment, the pharmacogenomics (i.e., the study of the relationship between an individual's genotype and that individual's response to a foreign compound or drug) of the individual can be considered. Differences in metabolism of therapeutics can lead to severe toxicity or therapeutic failure by altering the relation between dose and blood concentration of the pharmacologically active drug. Thus, the pharmacogenomics of the individual permits the selection of effective agents (e.g., drugs) for prophylactic or therapeutic treatments based on a consideration of the individual's genotype. Such pharmacogenomics can further be used to determine appropriate dosages and therapeutic regimens. Accordingly, the activity of a severe or persistent asthma-related gene product polypeptide, expression of a severe or persistent asthma-related gene product nucleic acid, or mutation content of a severe or persistent asthma-related gene product gene in an individual can be determined to thereby select an appropriate agent(s) for therapeutic or prophylactic treatment of the individual.

Pharmacogenomics deals with clinically significant hereditary variations in the response to drugs due to altered drug disposition and abnormal action in affected persons. See, e.g., Linder (1997) Clin. Chem. 43(2): 254-266. In general, two types of pharmacogenetic conditions can be differentiated. Genetic conditions transmitted as a single factor altering the way drugs act on the body are referred to as “altered drug action.” Genetic conditions transmitted as single factors altering the way the body acts on drugs are referred to as “altered drug metabolism.” These pharmacogenetic conditions can occur either as rare defects or as polymorphisms. For example, glucose-6-phosphate dehydrogenase (G6PD) deficiency is a common inherited enzymopathy in which the main clinical complication is hemolysis after ingestion of oxidant drugs (anti-malarials, sulfonamides, analgesics, nitrofurans) and consumption of fava beans.

As an illustrative embodiment, the activity of drug metabolizing enzymes is a major determinant of both the intensity and duration of drug action. The discovery of genetic polymorphisms of drug metabolizing enzymes (e.g., N-acetyltransferase 2 (NAT 2) and cytochrome P450 enzymes CYP2D6 and CYP2C19) has provided an explanation as to why some patients do not obtain the expected drug effects or show exaggerated drug response and serious toxicity after taking the standard and safe dose of a drug. These polymorphisms are expressed in two phenotypes in the population, the extensive metabolizer (EM) and poor metabolizer (PM). The prevalence of PM is different among different populations. For example, the gene coding for CYP2D6 is highly polymorphic and several mutations have been identified in PM, which all lead to the absence of functional CYP2D6. Poor metabolizers of CYP2D6 and CYP2C19 quite frequently experience exaggerated drug response and side effects when they receive standard doses. If a metabolite is the active therapeutic moiety, a PM will show no therapeutic response, as demonstrated for the analgesic effect of codeine mediated by its CYP2D6-formed metabolite morphine. The other extreme are the so called ultra-rapid metabolizers who do not respond to standard doses. Recently, the molecular basis of ultra-rapid metabolism has been identified to be due to CYP2D6 gene amplification.

Thus, the activity of a severe or persistent asthma-related gene product polypeptide, expression of a nucleic acid encoding the polypeptide, or mutation content of a gene encoding the polypeptide in an individual can be determined to thereby select appropriate agent(s) for therapeutic or prophylactic treatment of the individual. In addition, pharmacogenetic studies can be used to apply genotyping of polymorphic alleles encoding drug-metabolizing enzymes to the identification of an individual's drug responsiveness phenotype. This knowledge, when applied to dosing or drug selection, can avoid adverse reactions or therapeutic failure and thus enhance therapeutic or prophylactic efficiency when treating a subject with a modulator of activity or expression of the polypeptide, such as a modulator identified by one of the exemplary screening assays described herein.

### Methods of Treatment

The present invention provides for both prophylactic and therapeutic methods of treating a subject at risk of (or susceptible to) a disorder or having a disorder associated with aberrant expression or activity of a severe or persistent asthma-related gene product polypeptide and/or in which the severe or persistent asthma-related gene product polypeptide is involved.

The present invention provides a method for modulating or treating at least one severe or persistent asthma-related gene product related disease or condition, in a cell, tissue, organ, animal, or patient, as known in the art or as described herein, using at least one severe or persistent asthma-related gene product antagonist. Compositions of severe or persistent asthma-related gene product antagonist may find therapeutic use in the treatment of severe or persistent asthma or related conditions, such as ulcerative colitis or other TNF-mediated disorders.

The present invention also provides a method for modulating or treating at least one TNF-mediated, immune related disease, in a cell, tissue, organ, animal, or patient including, but not limited to, at least one of gastric ulcer, inflammatory bowel disease, ulcerative colitis, Crohn's pathology, and the like. See, e.g., the Merck Manual, 12th-17th Editions, Merck & Company, Rahway, N.J. (1972, 1977, 1982, 1987, 1992, 1999), Pharmacotherapy Handbook, Wells et al., eds., Second Edition, Appleton and Lange, Stamford, Conn. (1998, 2000), each entirely incorporated by reference.

Disorders characterized by aberrant expression or activity of the severe or persistent asthma-related gene product polypeptides are further described elsewhere in this disclosure.

### Prophylactic Methods

In one aspect, the invention provides a method for at least substantially preventing in a subject, a disease or condition associated with an aberrant expression or activity of a severe or persistent asthma-related gene product polypeptide, by administering to the subject an agent that modulates expression or at least one activity of the polypeptide. Subjects at risk for a disease that is caused or contributed to by aberrant expression or activity of a severe or persistent asthma-related gene product can be identified by, for example, any or a combination of diagnostic or prognostic assays as described herein. Administration of a prophylactic agent can occur prior to the manifestation of symptoms characteristic of the aberrancy, such that a disease or disorder is prevented or, alternatively, delayed in its progression. Depending on the type of aberrancy, for example, an agonist or antagonist agent can be used for treating the subject. The appropriate agent can be determined based on screening assays described herein.

### Therapeutic Methods

Another aspect of the invention pertains to methods of modulating expression or activity of severe or persistent asthma-related genes or gene products for therapeutic purposes. The modulatory method of the invention involves contacting a cell with an agent that modulates one or more of the activities of the polypeptide. An agent that modulates activity can be an agent as described herein, such as a nucleic acid or a protein, a naturally-occurring cognate ligand of the polypeptide, a peptide, a peptidomimetic, or other small molecule. In one embodiment, the agent stimulates one or more of the biological activities of the polypeptide. In another embodiment, the agent inhibits one or more of the biological activities of the severe or persistent asthma-related gene or gene product polypeptide. Examples of such inhibitory agents include antisense nucleic acid molecules and antibodies and other methods described herein. These modulatory methods can be performed in vitro (e.g., by culturing the cell with the agent) or, alternatively, in vivo (e.g., by administering the agent to a subject). As such, the present invention provides methods of treating an individual afflicted with a disease or disorder characterized by aberrant expression or activity of a severe or persistent asthma-related gene product polypeptide. In one embodiment, the method involves administering an agent (e.g., an agent identified by a screening assay described herein), or combination of agents that modulate (e.g., up-regulates or down-regulates) expression or activity. Inhibition of activity is desirable in situations in which activity or expression is abnormally high or up-regulated and/or in which decreased activity is likely to have a beneficial effect.

While having described the invention in general terms, the embodiments of the invention will be further disclosed in the following examples which should not be construed as limiting the scope of the claims.

### Example 1

### Study Design and Execution

The purpose of this pharmacogenomic study was to determine whether genetic variation in TNFα pathway genes—TNFα, TNFRSF1A, TNFRSF1B, and ADAM17—influences therapeutic response to treatment with golimumab, a monoclonal antibody to TNFα (anti-TNF) in patients with severe persistent asthma. In a multicenter, double-blind, placebo-controlled dose-ranging clinical trial, DNA samples from 144 caucasian patients with severe asthma on active treatment were analyzed for 53 SNPs in TNFα, TNFRSF1A, TNFRSF1B and ADAM17. Golimumab was administrated every 4 weeks at different dosages in the different treatment arms. The primary clinical end points were change from baseline to week 24 in % predicted FEV₁ and number of severe exacerbations from baseline through the first 24 weeks of treatment.

DNA samples were genotyped by MassARRAY. DNA sequencing was used when multiple polymorphisms were in very close proximity or when complex polymorphisms made MassARRAY analysis impossible. All genotyping data was automatically scored and then checked manually for accuracy.

Both single SNP and haplotype analyses were performed in order to assess the pharmacogenetic associations among asthma severity genes and baseline measures and treatment responses measured by numbers of sever exacerbations from baseline through the first 24 weeks of treatment. Individual SNPs and allele frequencies were estimated and tested for approximate conformation to Hardy-Weinberg equilibrium proportions by race. For multiple SNPs within a gene, estimates of linkage disequilibrium were obtained and this information was used to facilitate haplotype analyses.

### TNFRSF1A and TNFRSF1B Polymorphisms

The human TNFRSF1A gene resides on chromosome 12p13, with the coding region and 3-prime un-translated region (3′UTR) distributed over 10 exons spanning about 1 kb. It encodes a protein of 455 amino acids (SEQ ID NO: 4). The human TNFRSF1B gene resides on chromosome 1 p36 that spans nearly 43 kb. The gene consists of 10 exons and 9 introns. It encodes a protein of 461 amino acids.

Numerous SNPs were found for both genes, but many of them are in linkage disequilibrium, which means these SNPs are generally highly correlated and they are transmitted from generation to generation as a block. To simplify genetic screening, selected “tagging SNPs” were used in this study that best represent the entire spectrum of polymorphisms within a gene. The tagging SNPs are chosen for their close correlation with other SNPs, not by their potential functions. As an example, below is a LD plot of the tagging SNPs for the TNFRSF1A gene in the caucasian population. Other ethnic groups may have a different genetic structure and different LD plot.

A LD plot of 9 tagging SNPs in human TNFRSF1A gene. The entire gene sequence is shown as a white box on top, with each SNP indicated by a black bar. Pair-wise correlation between SNPs is represented in each blot, darker blots represent better correlation, and lighter blots represent poor correlation.

### Pharmacogenetic Association

The table below shows 3 genetic variations in the 2 TNF receptor genes that were significantly related to golimumab therapeutic response for the primary endpoint of number of severe asthma exacerbations. For example, for SNP rs4149581 (SEQ ID NO: 1) in the TNFSF1A gene, 54 homozygotes of the major allele had a mean frequency of 0.37 severe exacerbations compared to 0.83 exacerbations for the 72 heterozygotes, and 1.06 exacerbations for the 18 homozygotes of the minor allele. A chi square test resulted in a p value of 0.04 (p<0.05 is considered as significant), indicating that this SNP in TNFSF1A is associated with therapeutic response to golimumab in the study population: that the major allele confers better therapeutic response to golimumab than the minor allele.

A similar conclusion can be drawn for the 2 TNFRSF1B SNPs.

Genotype frequency in Golimumab treatment groups

| Gene and SNP | n = AA | EXSEVP | n = AB | EXSEVP | n = BB | EXSEVP | p |
|---|---|---|---|---|---|---|---|
| TNFRSF1B.3766730 | 99 | 0.54 | 38 | 1.16 | 1 | — | 0.03 |
| TNFRSF1B.590977 | 96 | 0.54 | 41 | 1.12 | 2 | — | 0.03 |
| TNFRSF1A.4149581 | 54 | 0.37 | 72 | 0.83 | 18 | 1.06 | 0.04 |

EXSEVP = mean number of Severe Exacerbations (imputed)

For reasons explained previously, these results are not limited to the 3 particular tagging SNPs, but any SNPs that are in LD with them. Thus, we conclude that there is a general genetic association between TNFRSF1A, TNFRSF1B and therapeutic response to golimumab in the study population. Further genetic and functional analyses maybe able to pinpoint to a particular SNP or a set of SNPs that offer a mechanistic explanation for why they influence individual response the therapy.

### ADVANTAGES

Although we identified these genetic biomarkers in a severe asthma population that was treated with golimumab, it is likely that the same association may exist with other anti-TNF therapeutic agents such as infliximab, adalimumab or etanercept, since the mechanism of action of this class of drugs is similar. They all act through the 2 TNFα receptors, and the receptor polymorphisms would possibly influence the individual response in similar fashion. The same association may also be extended to other immune mediated diseases, such as rheumatoid arthritis (RA), psoriatic arthritis (PsA), Crohn's disease (CD), ulcerative colitis (UC), psoriasis, and ankylosing spondylitis since TNFα is a known mediator in these diseases.

These genetic biomarkers can be easily assessed by taking a mouth swab sample from patients, and then assaying by a standard DNA test. The test can potentially be used as screening tool for prospective patients who are considering anti-TNFα treatment. The test result may allow patients and their physicians to make an educated decision by assessing the likelihood of benefiting from anti-TNFα therapy.

Although illustrated and described above with reference to certain specific embodiments, the present invention is nevertheless not intended to be limited to the details shown. Rather, the present invention is directed to the severe or persistent asthma-related genes and gene products. Polynucleotides, antibodies, apparatus, and kits disclosed herein and uses thereof, and methods for predicting responsiveness to treatment and controlling the levels of the severe or persistent asthma-related biomarker genes, and various modifications can be made in the details within the scope and range of equivalents of the claims and without departing from the spirit of the invention.

What is claimed:

1. A method for predicting the suitability of treatment for a TNF-mediated disorder in a subject, comprising:
(a) preparing a sample of nucleic acids from a specimen obtained from a subject;
(b) contacting the sample with a panel of nucleic acid segments consisting of at least a portion of at least one of, TNFRSF1A SNP rs4149581 (SEQ ID NO:1), TNFRSF1B SNP rs3766730 (SEQ ID NO:2) or TNFRSF1B SNP rs590977 (SEQ ID NO:3);
(c) determining whether nucleic acids from the sample exhibit single-nucleotide polymorphisms (SNPs) being in linkage disequilibrium (LD); and
(d) predicting the suitability of treatment for a TNF-mediated disorder based on the determination made in step (c).

2. The method of claim 1, wherein the treatment is an anti-TNF agent.

3. The method of claim 2, wherein the anti-TNF agent is golimumab.

4. The method of claim 2, wherein the anti-TNF agent is infliximab, adalimumab or etanercept.

5. The method of claim 2, wherein the TNF-mediated disorder is severe or persistent asthma.

6. The method of claim 1, wherein the degree of linkage disequilibrium observed for the sample is compared to at least one reference standard.

7. The method of claim 6, wherein the reference standard is from a lung biopsy, cheek swab, peripheral blood cells from an untreated severe or persistent asthma subject, a subject responsive to treatment, or a subject that is not responsive to treatment.

8. The method of claim 1, wherein the panel is an array of nucleic acid segments.

9. The method of claim 1, wherein the specimen includes peripheral blood cells obtained from a patient receiving treatment.

10. The method of claim 1, wherein the specimen is obtained one week, four weeks, or eight weeks after the start of treatment.

11. The method of claim 1, wherein a linkage disequilibrium for at least one nucleic acid present in the sample is indicative of the suitability of treatment.

12. The method of claim 1, wherein step (c) comprises evaluating the sample against a reference standard to determine the degree of linkage disequilibrium of nucleic acids present in the sample.

13. The method of claim 6, wherein the reference standard is from a patient prior to administration of a therapy, a placebo treated patient having a TNF mediated-related disorder, or a sample from a biobank.

14. The method of claim 1, wherein at least one member from the panel is selected from the group consisting of genes for cytokines, chemokines, proteins involved in extracellular matrix remodeling, angiogenesis associated growth factors, a cell adhesion molecule, and a myeloperoxidase.

15. The method of claim 1, wherein the specimen comprises peripheral blood cells from the subject.

16. The method of claim 1, wherein the specimen is a tissue biopsy of patients suspected of having severe or persistent asthma or patients diagnosed with severe or persistent asthma not undergoing treatment.

17. The method of claim 1, wherein the specimen is from a patient prior to administration of a therapy, a patient having a similar disease or condition treated with a placebo, or a sample from a biobank.

18. The method of claim 1, wherein step (b) further comprises exposing the sample to the panel of nucleic acid segments under moderate conditions, stringent conditions or very stringent conditions.

19. The method of claim 1, wherein step (c) further comprises determining whether nucleic acids from the sample exhibit single-nucleotide polymorphisms (SNPs) being in linkage disequilibrium (LD) with at least one of, TNFRSF1A SNP rs4149581 (SEQ ID NO: 1), TNFRSF1B SNP rs3766730 (SEQ ID NO: 2) or TNFRSF1B SNP rs590977 (SEQ ID NO: 3).

20. A kit for prognostic or diagnostic use, comprising oligonucleotides the same as, or complementary to, the nucleotide sequence of a marker gene, or the complementary strand thereof, and cells expressing the marker gene, wherein the marker gene is at least one of, TNFRSF1A SNP rs4149581 (SEQ ID NO: 1), TNFRSF1B SNP rs3766730 (SEQ ID NO: 2) or TNFRSF1B SNP rs590977 (SEQ ID NO: 3).

21. The kit of claim 20, wherein the kit is adapted for screening the suitability of a therapeutic agent for severe or persistent asthma.
